(19) United States
(12) Patent Application Publication
(10) Pub. No.: US 2011/0267271 A1
(43) Pub. Date: Nov. 3, 2011

(54) Mouse

(76) Inventor: Jack A. Atzmon, Englewood, NJ (US)

(21) Appl. No.: 13/143,908

(22) PCT Filed: Jan. 11, 2010
(86) PCT No.: PCT/US10/20622

§ 371 Date: Jul. 8, 2011

(30) Foreign Application Priority Data
Jan. 11, 2010 (US) 61/143702

(51) Int. Cl. G09G 5/08

(52) U.S. Cl. 345/163

(57) ABSTRACT

A mouse having a housing having a first surface configured to mate with a user's hand and a second substantially planar surface opposite the first surface, at least one motion tracking element arranged at least partially within the housing; and at least one display element arranged at least partially within the housing. The display is configured to display an image representing at least a portion of an image available on a main display of a computer.

### CROSS REFERENCE

This application claims priority to U.S. Provisional Patent Application No. 61/143,702, filed Jan. 9, 2009, the entirety of which is incorporated herein by reference.

### FIELD OF THE INVENTION

This invention is related to a pointing device for a computer and more particularly to an electro-mechanical mouse input device for a computer.

### BACKGROUND OF THE INVENTION

Mouse input devices for computers are well known in the art. The movement of the mouse in an X-Y plane typically actuates a mechanical, optical or electrical device within the mouse that produces X and Y position signals that are conveyed to the computer. The computer typically uses the mouse X and Y position signals to manipulate the display of the computer screen, allowing a user to control a program. A computer mouse also typically has one or more buttons which allow the user to further control a computer program. The mouse and mouse button allow the user to move a cursor or other pointing device to a specific area of the computer screen and depress the one or more buttons to activate specific computer program functions. Pressing the button downward actuates the mouse buttons.

A computer mouse is one of the indispensable peripherals for controlling a computer. Computer mice include the conventional roller-type mouse, track-ball type mouse, touch pad sensitive type mouse, and the optical mouse.

### SUMMARY OF THE INVENTION

Disclosed is a mouse having a touch sensitive surface. The mouse is typically one of a laser mouse, an optical mouse, a mechanical ball mouse, and the like. In a preferred embodiment, the top surface of the mouse comprises a display.

In one embodiment, the mouse is configured so that a display in the base of the mouse is magnified on the touch sensitive surface of the mouse. The mouse provides standard mouse functionality and the touch sensitive surface is configured to operate as a touch screen.

In one embodiment, the mouse is configured as a magnifier. When the screen pointer corresponding to the mouse is pointed anywhere on the computer's screen, that area appears magnified on the mouse.

In another embodiment, the mouse functions as an auxiliary display. Keys from a keyboard can be dragged to the mouse to improve inputs for programmers, garners, or graphic designers. For instance, delete and insert keys, arrow keys, etc. can be dragged and dropped onto the mouse to function as virtual keys.

In one embodiment, the mouse is provided with a clear cover to protect the touch sensitive surface when the mouse is only functioning as a mouse and/or auxiliary display.

In one embodiment, the mouse displays one or more web pages and preferably refreshes the one or more pages throughout the day. For example, a stock investor can select a stock graph that will remain on the mouse all day so the investor can track the stock, no matter what is displayed on the main screen.

Different screensaver options can be utilized on the mouse including a photo album screensaver that would cycle pictures throughout a sleep period.

The touch screen mouse is adapted for use as a master password store. All of a user's passwords are entered through the mouse, which enters the password for the user. In one embodiment, the passwords are stored according to biometric data.

In one embodiment, the touch screen mouse is configured for use as a note pad, and the notes can be transferred onto the main screen. The mouse can be used as an alarm clock; the mouse can vibrate itself or cause the computer to produce audio.

In one embodiment, the mouse can be wired or wireless and can have USB ports in it. Another embodiment includes software that provides for use the optics, built in laser, or sensor of a cell phone to provide the cell phone with functionality to turn the phone into a touch screen mouse with a USB connection.

The mouse has interconnectivity that allows for seamless transition from computer to mobile like calendar and contacts as well as documents, and the like.

In one embodiment, the mouse comprises a plurality of buttons such as right and left mouse buttons and a scroll wheel. The touch sensitive surface of the mouse can be configured to mimic physical embodiments of buttons and scroll wheels.

In one embodiment, the surface of the mouse is a touch sensitive LCD display. In another embodiment, the surface of the mouse is touch-sensitive and the general shape acts to magnify a display in the base of the mouse. In yet another embodiment, the mouse is not touch sensitive but provides a display. The display is an LCD display, a plasma display, or the like. The user can view the display device or the display can be projected onto the mouse body. All or a portion of the mouse body is configured to have the display projected thereon. Alternatively, the mouse body is the display.

In one embodiment, the mouse display functions as a riflescope or other tool or device to aid in game play. The display can also guide the user's fingers for complex touch screen maneuvers.

### BRIEF DESCRIPTION OF THE FIGURES

FIG. 1 is a top view of a mouse according to an embodiment of the invention; and

FIG. 2 is a side view of the mouse of FIG. 1.

### DETAILED DESCRIPTION OF THE PREFERRED EMBODIMENT

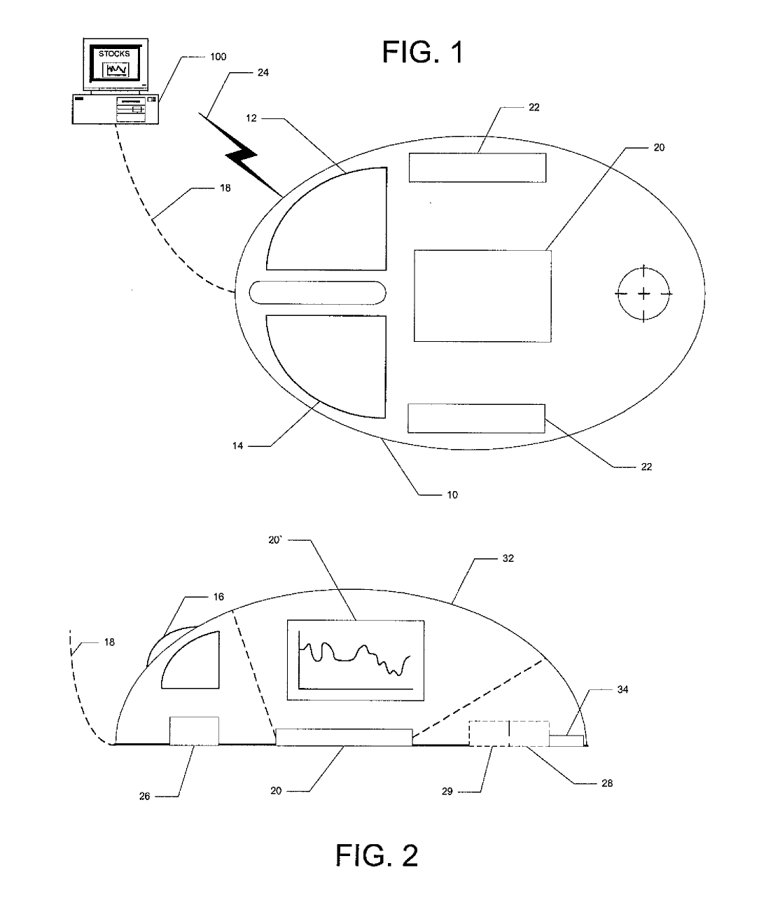

FIG. 1 is a top view of a mouse 10 according to an embodiment of the invention. As shown, the mouse 10 comprises a right mouse button 12, a left mouse button 14, and a scroll wheel 16. The right mouse button 12 and left mouse button 14 are implemented as mechanical buttons or touch sensitive buttons. Similarly, the scroll wheel is implemented as mechanical scroll wheel or touch sensitive scroll wheel. In one embodiment, the mouse further comprises at least one touch sensitive function button or touch sensitive area 22. In a preferred embodiment, the touch sensitive area 22 is user configurable. The cursor control or position determining means 26 for the mouse 10 can be a trackball, laser, optics, CCD element, or the like. While the preferred embodiment is disclosed as a mouse 10, the invention can be embodied in a joystick, a track ball, or the like.

The mouse 10 includes a display 20. The display 20 is one of an LCD display, a plasma display, an LED display, or the like. The display 20 typically comprises an array of pixels arranged in two orthogonal dimensions to form a two go dimensional display, with X and Y coordinates used to indicate the location of each pixel in the array. The display 20 is configured to display a portion of the image presented on a main monitor of computer 100 to which the mouse is connected. In one embodiment, display 20 is arranged a distance from a surface of the mouse body. Preferably, the mouse body is configured to magnify the displayed images. The image is magnified to an area 32. In one embodiment, the display 20 is arranged proximate to a surface of the mouse 10. At least a portion of the mouse surface is a touch panel such that the mouse functions as a touchscreen. In one embodiment, the display 20 is adapted to the contour of the mouse 10. The image displayed on display 20 is magnified due to the shape and refractive index of the mouse body. Alternatively, a Fresnel lens or other magnifying lens is used.

The mouse 10 is connected to the computer 100 via at least one of a wired connection 18, i.e., a PS/2 or USB connection or wireless connection 24, i.e., a Bluetooth connection. The mouse positioning data as well as the image data and mouse button controls are transferred between the mouse and the computer via this connection. In one embodiment, the mouse 10 includes a USB port 34. This external USB port 34 can be used to plug in additional devices.

In one embodiment, the mouse 10 comprises a memory 28. The memory 28 is configured to store photos for use as a screensaver for display 20. The memory 28 can also store button configurations for touch sensitive areas 22. The mouse 10 preferably includes a microprocessor 29. The microprocessor 29, in conjunction with the memory 28, provides functionality for the display 20 and the various touch sensitive surfaces. The user can configure the touch sensitive areas 22 of the mouse 10. In one embodiment, the touchscreen can be used for fingerprint recognition or other input.

A central processing unit (CPU) of the computer 100 or processor 29 performs the functions that will be described below. The CPU/processor can be any of a number of well-known devices. The mouse 10 includes the memory 29, which may comprise both random access memory (RAM) and read-only memory (ROM).

The display device 20 is configurable by at least one of the microprocessor 29 and the computer 100 to which mouse 10 is connected. The user is able to configure the display 20 to display all or part of the image displayed on the main display of the computer 100 to which the mouse 10 is connected.

In one embodiment of the invention, as the mouse 10 moves the cursor on the display of computer 100, a region of the display proximate to the cursor is magnified. In this manner, a zoom function can be easily implemented without varying the main display of the computer 100 as the magnified image is displayed on the display 20 of mouse 10.

As shown in FIG. 2, display 20′ displays a portion of the display of the computer to which the mouse 10 is connected. Specifically, the display 20′ displays only a stock chart. In a preferred embodiment, the display 20′ continuously updates or refreshes. Similarly, the display 20 can be configured to display photos or other images stored on the computer or in the memory 28.

In one embodiment, the mouse 10 is configurable as a target sight for gaming. In this embodiment, a target sight 30 is displayable on the display 20. The user preferably moves the sight 30 using a touch sensitive surface of the mouse 10 to track a target also displayed on the display 20. Shooting using the sight 30 can be accomplished using the mouse buttons 12 or 14 or a user configurable button 22 or a double click on the sight 30.

The display 20 for the mouse 10 can be configured using the computer 100 or, alternatively, the display 20 can be configured using a touch menu generated by the microprocessor 29. In one embodiment, the touchscreen can be used to enter passwords that are stored in the memory 28. Alternatively, the passwords are entered using computer 100. Passwords can also be stored on a USB fob that is plugged into USB port 34.

In one embodiment of the invention, the mouse 10 is a cellular telephone running a mouse application. The display for the telephone functions as the display 20. A user is able to have a selected portion of the main screen of computer 100 displayed on the cellular telephone's display. In one embodiment, the cellular telephone's camera is used for cursor control of the computer 100. Alternatively, position sensors in the cellular telephone are used for cursor control.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described with reference to block diagrams, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

I claim:

1. A mouse comprising:
a housing having a first surface configured to mate with a user's hand and a second substantially planar surface opposite the first surface
at least one motion tracking element arranged at least partially within the housing; and
at least one display element arranged at least partially within the housing, the display configured to display an image representing at least a portion of an image available on a main display of a computer.

2. The mouse of claim 1, wherein the display element is configured to display the image by projecting the image on at least a portion of the housing.

3. The mouse of claim 2, wherein the at least a portion of the housing where the image is projected is configured as a touch sensitive input.

4. The mouse of claim 2, further comprising:
a right mouse button arranged on the housing;
a left mouse button arranged on the housing; and
at least one user configurable touch sensitive input arranged on the housing.

5. The mouse of claim 2, wherein the at least a portion of an image available on a main display of a computer is magnified by the mouse housing.

6. The mouse of claim 2, further comprising a user accessible memory.

7. The mouse of claim 6, wherein the user accessible memory is configured to store at least one of passwords and images.

8. The mouse of claim 7, wherein the mouse is configured to display the stored images as a screen saver for the display.

9. The mouse of claim 2, wherein the display is one of an LCD display and a plasma display.

10. The mouse of claim 2, wherein the mouse is configured to be connected to the computer by at least one of a USB connection and a wireless connection.

11. The mouse of claim 10, wherein the wireless connection is a Bluetooth connection.

12. The mouse of claim 1, wherein the display element is located proximate to at least a portion of the housing.

13. The mouse of claim 12, wherein the at least a portion of the housing where the display element is located is configured as a touch sensitive input.

14. The mouse of claim 12, further comprising:
a right mouse button arranged on the housing;
a left mouse button arranged on the housing; and
at least one user configurable touch sensitive input arranged on the housing.

15. A mouse comprising:
a housing having a first surface configured to mate with a user's hand and a second substantially planar surface opposite the first surface
at least one motion tracking element arranged at least partially within the housing; and
at least one display element arranged at least partially within the housing, the display configured to display an image.

16. The mouse of claim 15, wherein the image is at least a portion of an image available on a main display of a computer.

17. The mouse of claim 15, wherein at least a portion of the image is not available on a main display of a computer.

18. The mouse of claim 15, wherein the at least a portion of the housing is a touch sensitive input.

19. The mouse of claim 18, wherein the touch sensitive input is configured as a biometric input.
